(19) United States
(12) Patent Application Publication
(10) Pub. No.: US 2005/0037703 A1
(43) Pub. Date: Feb. 17, 2005

(54) Device for producing sausage-type products

(76) Inventors: Gilles Bocabeille, Rennes (FR); Jacques Le Paih, Plumeliau (FR)

Correspondence Address: James H Patterson;Patterson Thuente Skaar & Christensen, 4800 IDS Center, 80 South 8th Street, Minneapolis, MN, 55402, US

(21) Appl. No.: 10/494,112

(22) PCT Filed: Oct. 10, 2002
(86) PCT No.: PCT/FR02/03444

(30) Foreign Application Priority Data
Oct. 30, 2001 (FR) 01 13998

(51) Int. Cl. A22C 11/00

(52) U.S. Cl. 452/32; 452/37

(57) ABSTRACT

The invention relates to a device that is used for the continuous productions of sausage-type products comprising a bead which is covered with a skin that is obtained by means of gelation. For this purpose, the inventive device comprises a coextrusion head which delivers into a gelation tube. According to the invention, the tub is circular in shape and defines an annular, peripheral channel in which the bead exiting the coextrusion head can be wound into a plurality of coils before leaving the gelation bath. Moreover, means are provided for creating a current in the bath so that the bead is driven continuously at more or less the coextrusion speed.

Within the context of this invention, these products consist of a strand made up of minced meat or fish and/or vegetables covered with a skin and cut up into portions, having any cross-sectional shape, although generally round. And concerning the production of these products, they are obtained by coextrusion of a strand coated with an initial base comprising, for example, one or more hydrocolloids such as sodium alginate or pectate, pectin, carrageenans, etc., which base is intended to form the skin by gelation in a bath downstream from the coextrusion means. After being immersed in the bath for a specific period of time, the strand is cut into portions, rinsed, dried, then packaged. In a continuous production mode, the strand exiting the coextrusion head passes into the gelation bath stretched out horizontally so as to determine the required immersion time.

Therefore, a continuous production line for such products typically includes a device made up of a coextrusion head dispensing into the upstream end of a gelation tank, the length of which is determined with respect to the coextrusion speed and required dwell-time or immersion time for the shaped strand. But on either side of this device, the production line may most often include means common to the production of traditional sausage or other products, such as a stuffer-type storage means upstream from the coextrusion head and a portion-producing machine downstream from the gelation tank, which is equipment that many manufacturers already possess. However, for them, the problem is to therein incorporate the aforesaid device, due to the significant length of the gelation bath. And in any event, this length is excessive due to the ground dimensions that it produces.

The invention results from a search to eliminate this disadvantage, in other words to very substantially reduce the overall dimensions of a gelation tank such as this, without thereby requiring a change in the production parameters, which are the coextrusion speed and the immersion time in the bath, and taking into account the fact that, upon exiting the extrusion head, the shaped strand remains fragile and brittle for a good portion of the immersion time in the gelation bath.

According to the invention, in a device for continuous production of sausage-type products consisting of a strand covered with a skin obtained by gelation, including to this end a coextrusion head dispensing into a tank containing a gelation bath, said tank is circular in shape and defines an annular peripheral channel in which said strand exiting from the coextrusion head can be wound in a plurality of turns around means delimiting the inside of said channel, before coming back out of said gelation bath, means also being provided to create a current in the latter, in order to continuously entrain said strand substantially at the coextrusion speed.

A simple and therefore preferred way of creating said current for entraining said strand into the gelation bath is to provide for said tank to be circular in shape and rotational around its axis of rotation, in order to be driven in rotation in such a way that the circumferential speed of the inside of said channel is substantially equal to the coextrusion speed; this has the additional advantage of almost eliminating the relative movement between said strand and the means delimiting the inside of said annular channel around which it is wound.

In one preferred embodiment of the invention, said tank containing the gelation bath is a substantially cylindrical vat, and it may comprise a central dome in order to define said annular peripheral channel. Said annular channel advantageously communicates with the inside of said dome, e.g., by way of perforations in the wall of the latter, in order to increase the volume and consequently the operating endurance of the gelation bath.

These characteristics and advantages of the invention, as well as others, will become more apparent in the following description, given in relation to the appended drawings wherein:

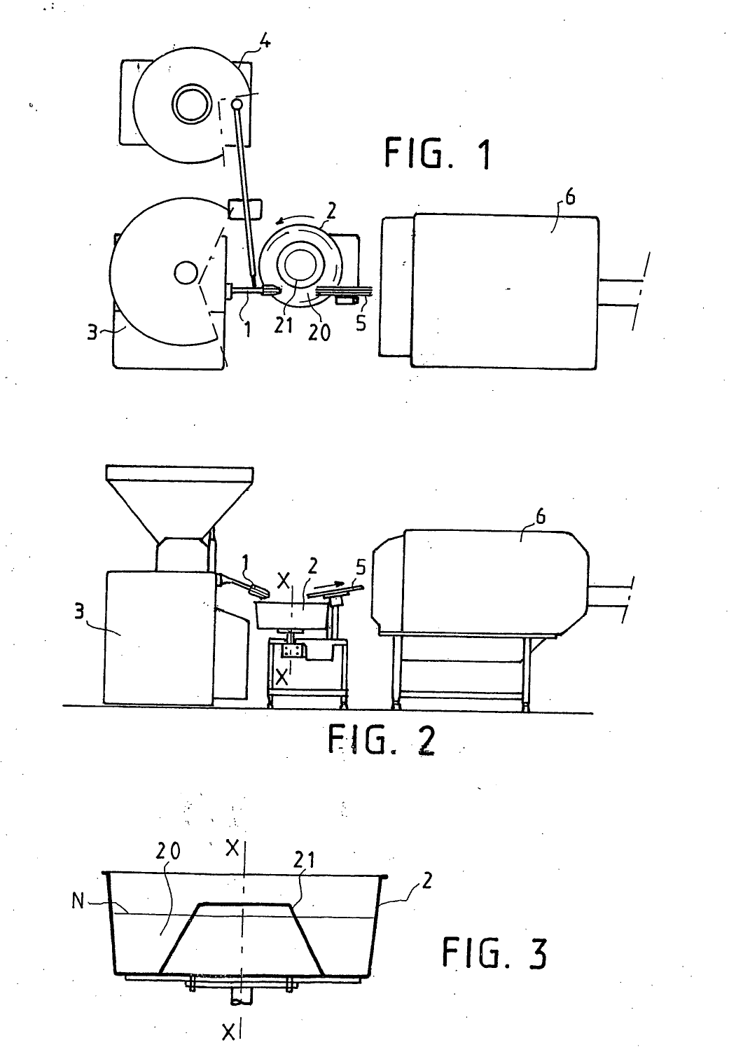

FIGS. 1 and 2 are respective top and side schematic views of a device according to the invention; and

FIG. 3 is a schematic axial section of a gelation tank forming part of the device of FIGS. 1 and 2.

Considering first FIGS. 1 and 2, they illustrate the basic features of a device according to the invention for the continuous production of sausages, which, at its upstream end, comprises a coextrusion head 1 dispensing a strand coated with an initial base into a gelation bath contained inside a tank 2. The strand must be immersed therein for a certain period of time in order to achieve successful gelation of its skin, which, together with the extrusion speed, will determine an immersion length of this strand.

The coextrusion head 1 can be supplied by means of a conventional piece of equipment for the formation of the strand, known as a “stuffer,” designated by the reference 3 in FIGS. 1 and 2, and by an assembly 4 made up of a storage hopper and a pump for the formation of the surface layer.

Downstream from the gelation tank 2, the strand together with its skin is taken up again for later processing which, in the example shown, involves passing it through a portion-producing machine 6. The latter may be a conventional machine, such as the one constituting the object of French Patent No. 2 725 876 by the company Nijal S. A.

Thus, in actual practice, it is seen that the device according to the invention may comprise a stuffer and a portion-producing machine that are already at the disposal of potential users in conventional sausage production lines.

And therefore, one of the major advantages of the invention is to enable a gelation tank to be easily integrated into these already existing lines.

In order to do this, and in accordance with the invention, the gelation tank 2, as it better appears in FIG. 3 where it is shown as an axial section, is a substantially cylindrical vat, preferably flared slightly towards the top, whose centre section is occupied by a dome 21, which is preferably slightly tapered with its large base on the bottom of the vat 2. The dome 21 thus defines a trough-shaped, annular peripheral channel 20 inside the vat 2, where the strand exiting the coextrusion head 1 will be received.

The latter, as shown in FIGS. 1 and 2, dispenses in a tangent direction and downwardly into the channel 20, which has a sufficient height and length to enable the strand to be loosely wound several times around the central dome 21, i.e., over the length corresponding to the required immersion time, before re-emerging while being taken up onto a conveyor 5, itself oriented in a tangent direction. It is shown in the same alignment as the coextrusion head 1, but, of course, it may have any direction in relation thereto.

According to another characteristic of the invention, the gelation bath moves longitudinally inside the channel 2, at a speed substantially equal to the coextrusion speed, in order to continuously entrain the immersed strand; and this carrying current is advantageously obtained by making the entire tank 2 rotate around its axis of rotation X-X and in the flow direction of the coextrusion head 1. The fact that the tank 2 is rotating also has an advantage in that there is practically no relative displacement between the immersed strand and the side wall of the dome 21, which might therefore be replaced by another type of structure, such as a series of vertical bars.

For illustrative, non-limiting purposes, yet substantiated by experimental testing, the tank 2 may have an average diameter as small as 0.60 m, approximately, with a channel 20 of an average width of 0.15 m, in order to loosely accommodate at least ten turns of the strand wound around the dome 21, corresponding to a length of 10 to 12 metres; and it can rotate at a speed of the order of 20 revolutions/minute. Nevertheless, of course, reliability can be improved by increasing the diameter of the tank 2 and by consequently reducing the number of turns of the strand. On the other hand, as illustrated schematically by the level line N in FIG. 3, the entire volume of the tank 2 below the top of the dome 21, including the interior space of the latter, is preferably available to the gelation bath, in order to increase its operating endurance. To this end, the channel 20 must be designed to communicate with the interior of the dome 21, by way of passages, for example, consisting of perforations in the wall thereof.

1. A device for continuous production of sausage-type products comprising a strand covered with a skin obtained by gelation, including a coextrusion head dispensing into a tank containing a gelation bath, wherein the tank is circular in shape and defines an annular peripheral channel in which said strand exiting from the coextrusion head can be wound in a plurality of turns around structure delimiting the inside of said channel, before re-emerging from said gelation bath, means also being provided to create a current in the latter, in order to continuously entrain said strand substantially at the coextrusion speed.

2. A device as claimed in claim 1, the tank being circular in shape and adapted for rotation around ban axis of rotation, such that the circumferential speed of the inside of the channel is substantially equal to the coextrusion speed.

3. A device as claimed in claim 1, the tank containing the gelation bath being a substantially cylindrical vat.

4. A device as claimed in claim 3, the vat comprising a central dome defining the annular peripheral channels.

5. A device as claimed in claim 4, the annular channel communicating with the interior of the dome in order to increase the volume and consequently the operating endurance of the gelation bath.

6. A device as claimed in claim 5, the channel communicating with the interior of the dome by way of perforations in the wall of the latter.

7. A device as claimed in claim l, the coextrusion head oriented to dispense in a tangent direction and downwardly into the channels of the gelation tanks.

8. A device as claimed in claim 1 including a take-up conveyors for the strand exiting the gelation tank oriented above the channel, inclined and oriented in a tangent direction.
